(19) United States
(12) Patent Application Publication
(10) Pub. No.: US 2024/0172896 A1
(43) Pub. Date: May 30, 2024

(54) Cooking Vessel With Handle Attached By Two Superimposed Rivets

(71) Applicant: SEB S.A., Ecully (FR)

(72) Inventor: Christophe Lorthioir, Bloyes (FR)

(73) Assignee: SEB S.A., Ecully (FR)

(21) Appl. No.: 18/283,613

(22) PCT Filed: Mar. 22, 2022
(86) PCT No.: PCT/EP2022/057482

§ 371 Date: Sep. 22, 2023

(30) Foreign Application Priority Data
Mar. 24, 2021 (FR) FR2102950

(51) Int. Cl. A47J 45/06; F16B 5/04

(52) U.S. Cl. CPC A47J 45/061; F16B 5/04

(57) ABSTRACT

A cooking vessel includes a side wall and a handle. The handle includes a connecting piece attached to the side wall. The connecting piece includes an axial portion that extends parallel to the side wall and that is attached to the side wall by at least two rivets.

The at least two rivets are arranged in at least two parallel horizontal planes H1, H2, separated by a distance D and the axial portion extends laterally to a vertical plane, perpendicular to the side wall, over a width L less than 30 millimeters, preferably less than 25 millimeters.

### TECHNICAL FIELD

The present invention relates to a cooking vessel comprising a riveted handle, particularly a frying pan, a saucepan, a skillet or a Dutch oven.

### STATE OF THE ART

Document US20150114973 describes a cooking vessel comprising a side wall and a handle. The handle comprises a connecting piece attached to the side wall. The connecting piece comprises an axial portion that extends parallel to the side wall and that is attached to the side wall by at least two rivets. The, at least, two rivets are arranged in a horizontal plane, with sufficient spacing to ensure secure attachment of the handle. The axial portion must therefore have a substantial width in the horizontal plane to insert the at least two rivets. The substantial width of the axial portion makes it necessary to adapt the shape of the axial portion to the specific shape of the side wall of this cooking vessel, in particular the bend radius of the axial portion, which must be identical to the bend radius of the side wall.

Cooking vessels as described in document US20150114973 are generally designed to form a range of cooking vessels of the same type but of different sizes. For example, the range of cooking vessels is of the saucepan type and the saucepans have different diameters. Thus, for each diameter corresponding to a cooking vessel, a handle must be designed and manufactured with a specific connecting portion in which the bend radius is adapted to the bend radius of the side wall.

Moreover, the multiplicity of handles fitted with a specific connecting portion limits the possibility of automating the production of such cooking vessels.

### SUMMARY OF THE INVENTION

This invention is intended to remedy these disadvantages.

The technical problem behind the invention is to provide a cooking vessel that has a design that is simple and economical to use.

The invention further aims to provide a cooking vessel with a construction that is safe and durable over time.

To this end, the invention relates to a cooking vessel comprising a side wall and a handle, said handle comprising a connecting piece attached to the side wall, said connecting piece comprising an axial portion that extends parallel to the side wall and that is attached to the side wall by at least two rivets, characterized in that the at least two rivets are arranged in at least two parallel horizontal planes H1, H2, separated by a distance D and in that the axial portion extends laterally to a vertical plane, perpendicular to the side wall, over a width less than 30 millimeters, preferably less than 25 millimeters.

In this way, the at least two rivets are arranged one above the other to create a narrow axial portion with a slim width. Such a slim axial portion thus helps make the handle compatible with the various sizes of cooking vessels in the same range.

Standardizing the handle in this way for one or more ranges of cooking vessels means that rivet installation can be automated, in particular by robots.

Advantageously, the handle comprises a vertical plane of symmetry PS, with the at least two rivets arranged in the vertical plane of symmetry PS.

Such an arrangement helps ensure a balanced load distribution when the cooking vessel is handled.

Preferably, the axial portion extends laterally on either side of the vertical plane of symmetry PS so as to have a constant width L.

Such a construction is highly economical in terms of materials, especially if the axial portion is made from a metal strip.

Advantageously, the axial portion of the connecting piece comprises an outer surface which has, in a horizontal cross-section plane, the shape of a circular arc with a radius R comprised between 7 and 12 centimeters, said outer surface resting at least partially on the side wall.

Such a radius is therefore a good compromise to allow the same axial portion to be attached to each individual circular-shaped cooking vessel in the same range, particularly a range of saucepans with diameters ranging from 14 centimeters to 28 centimeters.

Advantageously, the outer surface of the axial portion rests on the side wall on a contact surface SC which has, in a horizontal cross-section plane, a contact width LC greater than half the width L of the axial portion.

Preferably, the distance D is greater than 10 millimeters, preferably greater than 15 millimeters.

In this way, the at least two rivets are spaced sufficiently far apart to create an attachment that is resistant to stress when the cooking vessel is handled.

Advantageously, the connecting piece is made from a stainless-steel strip with a thickness greater than two millimeters.

This means that the connecting piece can be produced very economically.

Preferably, each rivet comprises a barrel with a diameter of less than 6 millimeters.

This small barrel diameter enables simultaneous riveting of two rivets for easy assembly.

Advantageously, the cooking vessel comprises two rivets.

This arrangement offers the best compromise between fastener strength and cost.

Preferably, the handle comprises a gripping part that is assembled to the connecting piece by overmolding.

Advantageously, the connecting piece comprises a radial portion that extends radially relative to the side wall from a junction end with the axial portion, the end being arranged immediately adjacent to an upper edge of the cooking vessel.

Thus, when stacking a cooking vessel with a small diameter into a cooking vessel with a larger diameter, the small-diameter cooking vessel will be able to fit substantially until the radial portion comes into contact with the upper edge of the larger-diameter cooking vessel.

Preferably, the radial portion extends radially from the side wall at an upward angle.

Thus, when stacking a cooking vessel with a small diameter into a cooking vessel with a larger diameter, the small-diameter cooking vessel will be able to fit even more substantially until the radial portion comes into contact with the upper edge of the larger-diameter cooking vessel.

Advantageously, the radial portion forms an angle greater than 20° with a horizontal plane, in a vertical cross-section plane.

Advantageously, the cooking vessel is a frying pan, a saucepan, a skillet or a Dutch oven.

Advantageously, the cooking vessel comprises an inner surface that comprises a surface coating or treatment.

Advantageously, the cooking vessel comprises an inner surface made of aluminum, the inner surface having a non-stick coating.

Advantageously, the cooking vessel comprises an inner surface made of stainless steel, the inner surface being polished.

The invention also relates to a set consisting of at least two cooking vessels comprising a side wall and the same handle, each cooking vessel being as previously described.

The handle attachment system for each cooking vessel is especially compact and enables a cooking vessel with a small diameter to be stacked inside a cooking vessel with a larger diameter, whereby the small diameter and the larger diameter can be similar, particularly within approximately two centimeters.

The heads of the at least two rivets of the larger-diameter cooking vessel are arranged in a vertical line of contact with the smaller-diameter cooking vessel with which it is stacked. Thus, the axial portion is narrow to present a vertically concentrated contact zone between the smaller-diameter cooking vessel and the larger-diameter cooking vessel.

Advantageously, each side wall of the at least two cooking vessels has an identical height h.

Thus, when stacking a small-diameter cooking vessel in a larger-diameter cooking vessel, the small-diameter cooking vessel can rest flat in the larger-diameter cooking vessel, with the radial portion of the small-diameter cooking vessel able to extend over the top edge of the larger-diameter cooking vessel.

As a result, stacking stability is improved and the risk of deterioration of the larger-diameter cooking vessel by the smaller-diameter cooking vessel is greatly reduced.

Advantageously, in the event that the connecting piece comprises a radial portion that extends radially relative to the side wall from a junction end with the axial portion, the end being arranged immediately adjacent to an upper edge of the cooking vessel, the radial portion of the small-diameter cooking vessel can more easily extend over the top edge of the larger-diameter cooking vessel.

Even more advantageously, in the event that the radial portion extends radially from the side wall at an upward angle, the radial portion of the small-diameter cooking vessel can even more easily extend over the top edge of the larger-diameter cooking vessel.

The invention could also relate to a set consisting of at least two cooking vessels comprising a side wall of the same height and the same handle, said handle comprising a connecting piece attached to the side wall, said connecting piece comprising an axial portion that extends parallel to the side wall and is attached to the side wall, the connecting piece comprising a radial portion that extends radially relative to the side wall from a junction end with the axial portion, the end being arranged immediately adjacent to an upper edge of the cooking vessel.

### BRIEF DESCRIPTION OF THE FIGURES

The purposes, aspects and advantages of the present invention, according to the description given below of a particular embodiment of the invention presented by way of non-limiting example, will be better understood by referring to the attached drawings in which:

FIG. 1 is a perspective view of a cooking vessel according to a first particular embodiment of the invention, the cooking vessel being a saucepan with a diameter of 20 centimeters,

FIG. 2 is a partial cross-section view along the vertical cross-section plane II-II of the cooking vessel shown in FIG. 1,

FIG. 3 is a partial cross-section view along the horizontal cross-section plane III-III of the cooking vessel shown in FIG. 1,

FIG. 4 is a partial cross-section view along the horizontal cross-section plane III-III of a cooking vessel from the same range as the cooking vessel in FIG. 1, the cooking vessel being a saucepan with a diameter of 16 centimeters,

FIG. 5 is a partial cross-section view along the horizontal cross-section plane III-III of a cooking vessel from the same range as the cooking vessel in FIG. 1, the cooking vessel being a saucepan with a diameter of 28 centimeters.

FIG. 6 is a partial cross-section view along the vertical cross-section plane VI-VI of the cooking vessel in FIG. 1 and of a cooking vessel with a smaller diameter, in particular a saucepan with a diameter of 18 centimeters, the two cooking vessels being stacked.

Only those elements required in order to understand the invention have been depicted. In order to facilitate interpretation of the drawings, the same elements are labeled with the same references across all the figures.

It will be noted that, in this document, the terms “horizontal,” “vertical,” “lower,” “upper,” “top,” “bottom,” “front,” “rear,” “longitudinal” and “transverse” used to describe the cooking vessel refer to this cooking vessel when in use, when sitting flat on a worktop or heating appliance.

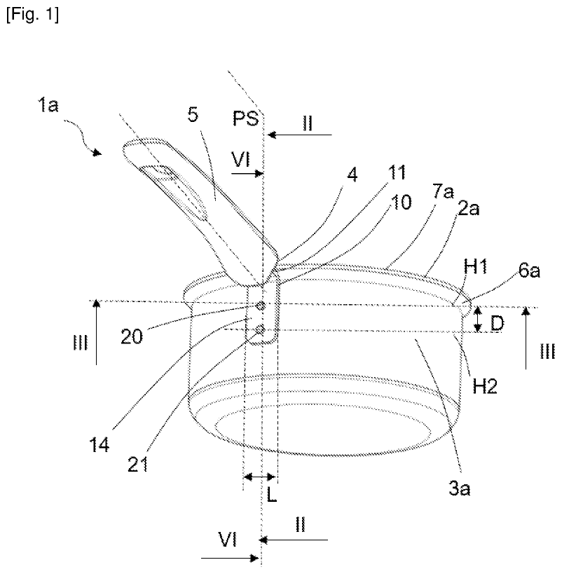

In a first embodiment shown in FIGS. 1 to 3, a cooking vessel 1a, which is a saucepan, comprises a body 2a that is 20 centimeters in diameter with a side wall 3a and a handle 4. The body 2a is made by stamping an aluminum disk. The handle 4 comprises a gripping part 5 and a connecting piece 10. The connecting piece 10 is attached to the side wall 3a. The connecting piece 10 has a radial portion 11 that extends radially relative to the side wall 3a, sloping upward relative to a substantially horizontal plane parallel to the plane on which the body 2a rests. The radial portion 11 forms an angle α equal to 25° with a horizontal plane, in a vertical cross-section plane. The gripping part 5 is assembled to the radial portion 11 of the connecting piece 10 by overmolding.

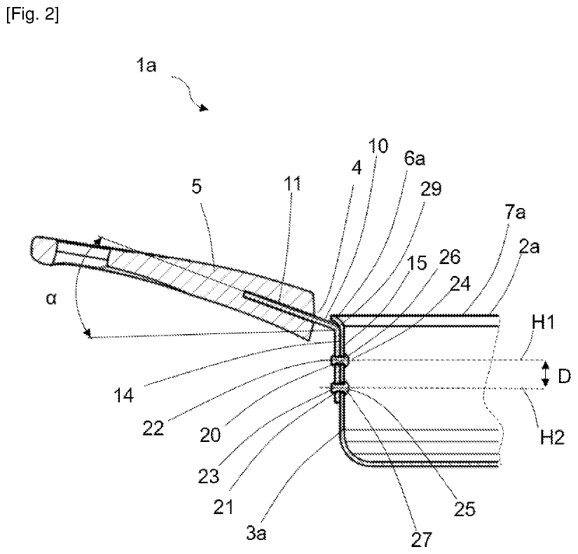

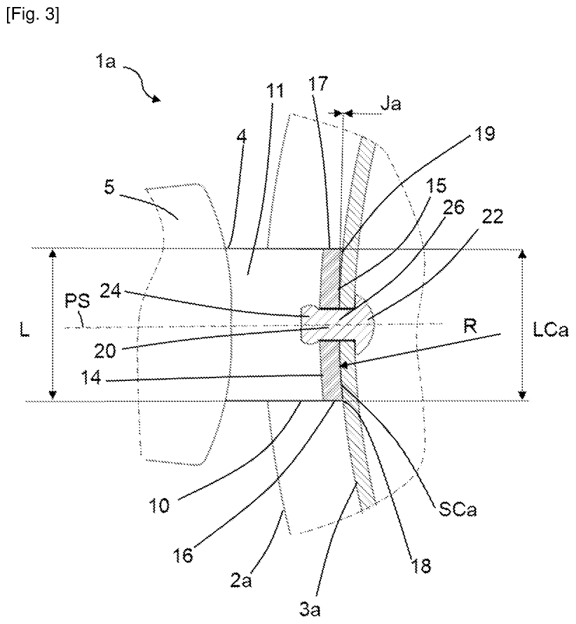

The connecting piece 10 comprises an axial portion 14 that extends parallel to the side wall 3a in a substantially vertical manner. The axial portion 14 of the connecting piece 10 is attached to the side wall 3a by two rivets 20, 21 arranged in two parallel horizontal planes H1, H2. The two parallel horizontal planes H1, H2 are separated by a distance D equal to 15 millimeters (FIG. 2). The handle 4 comprises a vertical plane of symmetry PS. The two rivets 20, 21 are arranged in the vertical plane of symmetry PS (FIG. 2). Each rivet 20, 21 comprises a head 22, 23 arranged inside the body 2a of the cooking vessel 1a (FIG. 3) and a cap 24, 25 extending outwards from the body 2a of the cooking vessel 1a, radially to the side wall 3a. The cap 24, 25 is the result of crimping the free end of the rivet 20, 21, opposite the head 22, 23, using a riveting tool, once the rivet 20, 21 has been assembled on the body 2a and the connecting piece 10. Each rivet 20, 21 comprises a barrel 26, 27 with a diameter equal to 4 millimeters.

The connecting piece 10 is made from a stainless-steel strip with a thickness equal to 3 millimeters and a width L equal to 25 millimeters. Thus, the axial portion 14 extends downwards and to either side of the vertical plane of symmetry PS to give a width L equal to 25 millimeters. In a horizontal cross-section plane, perpendicular to the plane of symmetry PS, the axial portion 14 of the connecting piece 10 has an outer surface in the shape of a circular arc with a radius R equal to 10 centimeters (FIG. 3).

The axial portion 14 has two lateral edges 16, 17, each with an outer rim 18, 19 facing the body 2a. As the radius R of the axial portion 14 is equal to the radius of the body 2a, there is no clearance Ja between the outer surface 15 of the axial portion 14 and the body 2a after assembly. The outer surface 15 rests on the body 2a on a contact surface SCa which, in a horizontal cross-section plane, has a contact width LCa equal to the width L of the axial portion 14.

The connecting piece 10 comprises a radial portion 11 that extends radially relative to the side wall 3a from a junction end 29 (FIG. 2) with the axial portion 14, the end 29 being arranged immediately adjacent to an upper edge 7a of the cooking vessel 1a. The side wall 3a is extended upwards by an outwardly curved portion 6a. The junction end 29 is arranged directly under the curved portion 6a.

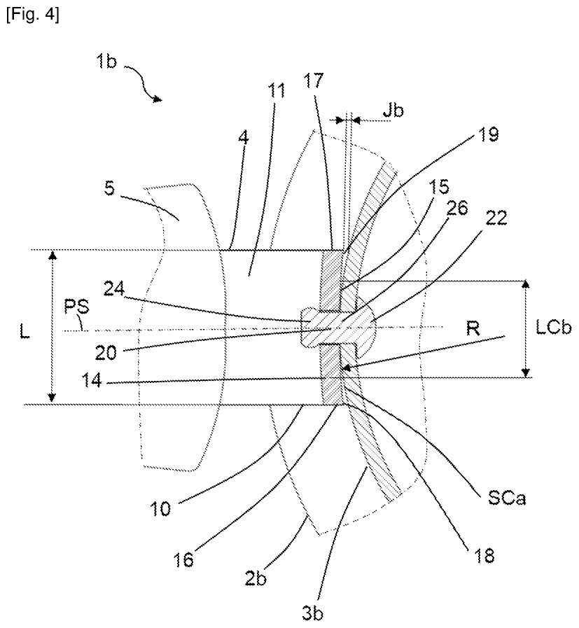

In a second embodiment shown in FIG. 4, a cooking vessel 1b, which is also a saucepan, comprises a body 2b that is 16 centimeters in diameter with a side wall 3b and the handle 4. The axial portion 14 of the connecting piece 10 is attached to the side wall 3b by the two rivets 20, 21, in the same way as for the cooking vessel 1a. As the radius R of the axial portion 14 is greater than the radius of the body 2b, there is a clearance Jb between each outer edge 18, 19 and the body 2b after assembly. The outer surface 15 of the axial portion 14 rests on the body 2b on a contact surface SCb which has, in a horizontal cross-section plane, a contact width LCb greater than half the width L of the axial portion 14. This is made possible by the force exerted by the two rivets 20, 21 on the axial portion 14 of the body 2b. In fact, once the rivets 20, 21 have been crimped, the side wall 3b of the body 2b is slightly deformed to increase the contact surface SCb. Such a contact surface SCb between the axial portion 14 and the body 3b [sic: 2b] is sufficient to ensure the lasting attachment of a small-diameter saucepan with a low filling capacity. Low filling capacity leads to limited stress when the cooking vessel is handled.

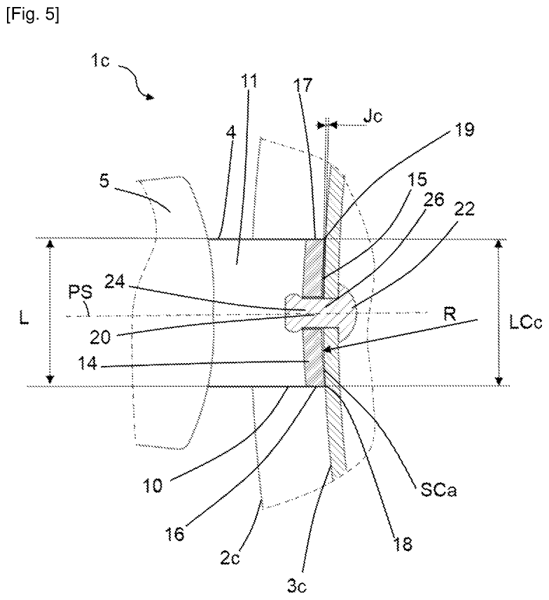

In a third embodiment shown in FIG. 5, a cooking vessel 1c, which is also a saucepan, comprises a body 2c that is 28 centimeters in diameter with a side wall 3c and the handle 4. The axial portion 14 of the connecting piece 10 is attached to the side wall 3c by the two rivets 20, 21, in the same way as for the cooking vessel 1a. As the radius R of the axial portion 14 is less than the radius of the body 2c, there is a clearance Jc between the outer surface 15 of the axial portion 14 and the body 2c, prior to assembly in the plane of symmetry PS. The outer surface 15 of the axial portion 14 rests on the body 2c on a contact surface SCc which, in a horizontal cross-section plane, has a contact width LCc. Before crimping the two rivets 20, 21, a force is applied to the axial portion 14 and to the body 2c to reduce or eliminate the clearance Jc. Thus, once the rivets 20, 21 have been crimped, the side wall 3c of the body 2c and the axial portion 14 are slightly deformed to increase the contact surface SCc so that the contact width LCc is almost equal to the width L of the axial portion 14. Such a contact surface SCc between the outer surface 15 of the axial portion 14 and the body 2c is necessary to ensure the lasting attachment of a large-diameter saucepan with a high filling capacity.

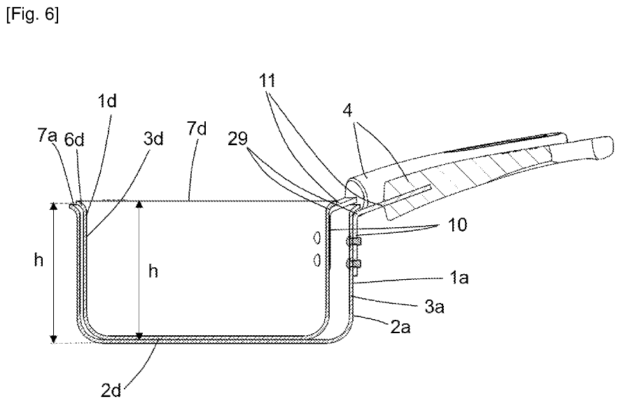

As shown in FIG. 6, a cooking vessel 1d, which is a saucepan, comprising a body 2d 18 centimeters in diameter with a side wall 3d and a handle 4. The side wall 3d is extended upwards by an outwardly curved portion 6d. The connecting piece 10 attached to the body 3d comprises the radial portion 11 that extends radially relative to the side wall 3d from the junction end 29. The junction end 29 of the handle 4 is arranged directly under the curved portion 6d, immediately adjacent to an upper edge 7d of the cooking vessel 1d. The radial portion 11 extends radially relative to the side wall 3d, sloping upward relative to a substantially horizontal plane parallel to the plane on which the body 2d rests. The radial portion 11 forms an angle α equal to 25° with a horizontal plane, in a vertical cross-section plane. The cooking vessel 1d is stored by stacking it in the cooking vessel 1a which comprises the body 2a that is 20 centimeters in diameter with a side wall 3a. The side wall 3a and the side wall 3d have the same height h.

In this way, the cooking vessels 1a, 1b, 1c, 1d fitted with the same handle 4 have a secure and lasting riveted attachment of the handle 4.

Of course, the invention is in no way limited to the embodiment described and illustrated, since this embodiment was only provided by way of example. Changes can still be made, particularly with regard to the constitution of the various elements or by substituting technical equivalents, without departing from the scope of protection of the invention.

Thus, in a non-illustrated variant, the handle 4 comprises a short gripping part forming a lug with a central opening, and the radial part is in the shape of a U arranged around half of the periphery of the central opening.

1. A cooking vessel comprising a side wall and a handle, said handle comprising a connecting piece attached to the side wall, said connecting piece comprising an axial portion extending parallel to the side wall and attached to the side wall by at least first and second rivets, wherein the at least first and second rivets are arranged in at least two parallel horizontal planes H1, H2, respectively, separated by a distance D and wherein the axial portion extends laterally to a vertical plane, perpendicular to the side wall, over a width L less than 30 millimeters.

2. The cooking vessel according to claim 1, wherein the handle comprises a vertical plane of symmetry PS, with the at least first and second rivets arranged in the vertical plane of symmetry PS.

3. The cooking vessel according to claim 2, wherein the axial portion extends laterally on either side of the vertical plane of symmetry PS so as to have a constant width L.

4. The cooking vessel according to claim 1, wherein the axial portion of the connecting piece comprises an outer surface having, in a horizontal cross-section plane, a shape of a circular arc with a radius R between 7 and 12 centimeters, said outer surface resting at least partially on the side wall.

5. The cooking vessel according to claim 1, wherein the distance D is greater than 10 millimeters.

6. The cooking vessel according to claim 1, wherein the connecting piece is made from a stainless-steel strip with a thickness greater than 2 millimeters.

7. The cooking vessel according to claim 1, wherein each of the first and second rivets comprises a barrel with a diameter of less than 6 millimeters.

8. The cooking vessel according to claim 1, wherein the handle comprises a gripping part assembled to the connecting piece by overmolding.

9. The cooking vessel according to claim 1, wherein the cooking vessel is a frying pan, a saucepan, a skillet or a Dutch oven.

10. The cooking vessel according to claim 1, wherein the connecting piece comprises a radial portion extending radially relative to the side wall from a junction end with the axial portion, the end arranged immediately adjacent to an upper edge of the cooking vessel.

11. The cooking vessel according to claim 10, wherein the radial portion extends radially relative to the side wall at an upward angle.

12. A set consisting of at least two cooking vessels comprising a body with a side wall and a handle, each of the at least two cooking vessel according to claim 1.

13. The set consisting of at least two cooking vessels according to claim 12, wherein each side wall of at least two cooking vessels has an identical height h.
